(19) United States
(12) Patent Application Publication
(10) Pub. No.: US 2026/0124480 A1
(43) Pub. Date: May 7, 2026

(54) UNIBODY AIR MAINTENANCE DEVICE FOR A DRY FIRE PROTECTION SYSTEM

(71) Applicant: The Reliable Automatic Sprinkler Co. Inc., Liberty, SC (US)

(72) Inventors: David Deurloo, Liberty, SC (US); Scott Hanson, Brandon, SD (US)

(21) Appl. No.: 19/381,765

(22) Filed: Nov. 6, 2025

Related U.S. Application Data
(60) Provisional application No. 63/717,316, filed on Nov. 7, 2024.

(51) Int. Cl. A62C 35/68; A62C 35/62

(52) U.S. Cl. CPC A62C 35/68; A62C 35/62

(57) ABSTRACT

A unibody air maintenance device includes a body that is a single, integral component.

The body has an inlet and an outlet. The inlet receives a pressurized gas and the outlet directs the pressurized gas to a dry fire protection system. A regulator is disposed within the body and maintains a pressure of the pressurized gas at a set pressure. A check valve is disposed within the body and opens to allow the pressurized gas to flow from the inlet towards the outlet and closes to prevent the pressurized gas from flowing from the outlet towards the inlet. A three-way valve is disposed within the body downstream of the inlet and upstream of the regulator. The three-way valve allows the pressurized gas to flow towards the regulator in a regulate position and to prevent the pressurized gas from flowing through the unibody air maintenance device in an off position.

### CROSS-REFERENCE TO RELATED APPLICATION

This application claims priority to U.S. Provisional Application No. 63/717,316, filed Nov. 7, 2024, the entire contents of which is hereby incorporated by reference.

### FIELD OF THE INVENTION

The present invention relates generally to dry fire protection systems, and, in particular, to a unibody air maintenance device for such systems.

### BACKGROUND

Dry fire protection systems include sprinklers that are connected to piping that may be exposed to freezing conditions, such as in freezers, loading docks, or outdoor walkways. In dry fire protection systems, fluid supply pipes are positioned in a space in which fluid (e.g., water, fire protection fluid, etc.) in the fluid supply pipes are not subject to freezing. In the heated space, a valve, also referred to as a dry valve, is positioned to prevent the fluid from flowing to the sprinklers until there is a fire. In particular, the dry valve is held closed by a pressurized gas (e.g., compressed air, nitrogen, or the like) and prevents the fluid from flowing to the sprinklers. The sprinklers are attached to a pipe network filled with the pressurized gas, and the pipe network extends into a space in which the fluid would otherwise be subject to freezing.

A sprinkler comprises a frame deflector assembly, an inlet end connected to a pipe network of a fire suppression system, a plug seal at the inlet end to prevent fluid from exiting the sprinkler, an actuating mechanism to maintain the plug seal, and a fluid dispersion mechanism or a deflector. In a dry fire protection system, the plug seal of many sprinklers maintains the pressurized gas in the system piping. When an elevated temperature occurs, a thermally responsive support element fails, releasing the plug seal to allow air from the pipes to flow out of the pipes into the protected area through the sprinkler. The pressurized gas in the system decays (e.g., the pressure decreases) to a point where the dry valve automatically actuates, allowing water to enter the pipes. The fluid flows through the entire pipe network until reaching the sprinkler that has lost its element/seal upon detection of heat. Once the fluid arrives at the sprinkler, fluid flows through the sprinkler waterway towards the sprinkler deflector and is ultimately distributed by the sprinkler deflector.

In some embodiments, the dry valve is a pre-action valve that is controlled to open or to close by a controller. In particular, the controller receives a signal from a heat detector or a smoke detector and then sends an electrical signal to the pre-action valve to actuate the pre-action valve to open, allowing the fluid to enter the pipes.

There are several methods to fill such dry fire protection systems with the pressurized gas. To fill such systems with the pressurized gas, specialized equipment is needed to ensure that the pressure of the gas within the system is maintained at a pressure that allows the system to function as designed. One way to accomplish a set gas pressure in a fire protection system is to use a regulator type air maintenance device (AMD). Typically, a regulator type AMD includes a reservoir of higher gas pressure maintained at a pressure above the fire suppression system designed gas pressure. The path of gas under the normal operation comes into the inlet of the AMD, routed through the regulator and a restriction orifice proceeding into the system. The restriction orifice is sized so that the flow rate of an open sprinkler is more than the AMD can supply, so that the system will lose pressure upon sprinkler activation, but the AMD will be able to keep up with small leaks that occur in the system.

Generally, AMDs are manufactured, or are assembled, from off-the-shelf components. Current AMDs, however, include several components coupled together (e.g., by several threaded couplings) such that the regulator, the restriction orifice, and the valves are housed in separate components. Such AMDs are large, heavy, and prone to leaks due to the several threaded couplings, and are complex due to needing to actuate several valves to isolate certain components (e.g., the regulator, the restriction orifice, etc.) for maintenance.

In addition to keeping the system supplied with the designed gas pressure, another function for current AMDs is a “Quick Fill” bypass. Systems must be able to be returned to service in thirty minutes or less. Filling the system through the regulator and the restriction orifice would take too long, so AMDs have a bypass that bypasses the regulator and the restriction orifice so that the system can be filled quickly. Current AMDs also include a check valve in the path of the gas under normal operation. Some AMDs utilize a combination restriction orifice check valve or some AMDs include a check valve in the design of the regulator. The check valve is included to ensure that the system would not activate immediately if the air supply were temporarily removed from service, for example, during maintenance on the AMD.

Some AMDs also include a way to isolate the regulator at the AMD. For example, some AMDs have a device to isolate the regulator, typically, between two ball valves or one ball valve and a check valve. The ball valves are actuated manually, for example, by a maintenance technician. The regulator is the most complicated component, generally, with a diaphragm and small orifices. In this way, the regulator has the highest risk of failure, and, therefore, typically requires the most maintenance. Being able to isolate the regulator without affecting the fire protection system is preferable to perform maintenance on the regulator.

Due to the sensitivity of the regulator to small debris and the required restriction orifice, a strainer is typically present in the assembly to ensure scale and debris do not enter the regulator or the restriction orifice. The strainer can include a strainer basket or a catch basin that collects the small debris. The strainer also requires a lot of maintenance. Again, some AMDs allow for the isolation of the strainer along with the regulator. Being able to remove the strainer basket or the catch basin without taking the system out of service is desired.

AMDs typically also include a way to disassemble the unit to perform maintenance on the unit. AMDs include at least one union or connection (e.g., a threaded connection), and, typically, include two unions, for connecting the various components together during assembly of the AMD. The unions typically include a way to seal the unions so as to prevent leaks, but the seal can wear out after the AMD has been disassembled and reassembled a few times. Some AMDs also include a gauge port connected to a gauge for displaying the pressure through the AMD. Further, in AMDs that include a strainer, a check valve, and a regulator, an additional ball valve is required downstream of the regulator due to the check valve being upstream of the regulator.

### SUMMARY

In one embodiment, the present disclosure provides a unibody air maintenance device for a dry fire protection system. The unibody air maintenance device comprises a body that is a single, integral component, the body having an inlet and an outlet, the inlet being configured to receive a pressurized gas from a pressurized gas source and the outlet being configured to direct the pressurized gas to the dry fire protection system, a regulator disposed within the body and downstream of the inlet, the regulator being configured to maintain a pressure of the pressurized gas through the unibody air maintenance device at a set pressure, a check valve disposed within the body and downstream of the regulator, the check valve being configured to open to allow the pressurized gas to flow from the inlet towards the outlet and to close to prevent the pressurized gas from flowing from the outlet towards the inlet, and a three-way valve disposed within the body downstream of the inlet and upstream of the regulator, the three-way valve being configured to allow the pressurized gas to flow towards the regulator in a regulate position and to prevent the pressurized gas from flowing through the unibody air maintenance device in an off position.

In another embodiment, the present disclosure provides a system comprising a dry fire protection system configured to distribute water to a coverage area, a pressurized gas source configured to supply a pressurized gas to the dry fire protection system, a pressurized gas supply line configured to supply the pressurized gas from the pressurized gas source to the dry fire protection system, and a unibody air maintenance device fluidly coupled to the pressurized gas supply line. The unibody air maintenance device comprises a body that is a single, integral component, the body having an inlet and an outlet, the inlet being configured to receive the pressurized gas from the pressurized gas source and the outlet being configured to direct the pressurized gas to the dry fire protection system, a regulator disposed within the body and downstream of the inlet, the regulator being configured to maintain a pressure of the pressurized gas through the unibody air maintenance device at a set pressure, a check valve disposed within the body and downstream of the regulator, the check valve being configured to open to allow the pressurized gas to flow from the inlet towards the outlet and to close to prevent the pressurized gas from flowing from the outlet towards the inlet, and a three-way valve disposed within the body downstream of the inlet and upstream of the regulator, the three-way valve being configured to allow the pressurized gas to flow towards the regulator in a regulate position and to prevent the pressurized gas from flowing through the unibody air maintenance device in an off position.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1A is a schematic front view of a unibody air maintenance device (AMD) in a regulate position, according to the present disclosure.

FIG. 1B is a schematic cross-sectional view of the unibody AMD of FIG. 1A, taken along a longitudinal centerline axis of the unibody AMD, according to the present disclosure.

FIG. 2A is a schematic front view of the unibody AMD in a bypass position, according to the present disclosure.

FIG. 2B is a schematic cross-sectional view of the unibody AMD of FIG. 2A, taken along a longitudinal centerline axis of the unibody AMD, according to the present disclosure.

FIG. 3A is a schematic front view of the unibody AMD in an off position, according to the present disclosure.

FIG. 3B is a schematic cross-sectional view of the unibody AMD of FIG. 3A, taken along a longitudinal centerline axis of the unibody AMD, according to the present disclosure.

### DETAILED DESCRIPTION

Additional features, advantages, and embodiments of the present disclosure are set forth or apparent from a consideration of the following detailed description, drawings, and claims. Moreover, both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and the scope of the present disclosure.

As used herein, the terms “first,” “second,” and “third” may be used interchangeably to distinguish one component from another and are not intended to signify location or importance of the individual components.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for a unibody air maintenance device that has, in serial flow relationship, an inlet, a single three-way ball valve as the shutoff valve/bypass valve, a strainer, a regulator, a gauge port, a restriction orifice, and a check valve (that isolates the regulator and the strainer for maintenance, thus, removing the need for a second shutoff valve) in a single, unitary body, also referred to as a unibody. The unibody AMD also includes a bypass for bypassing the three-way ball valve, the strainer, the regulator, the gauge port, and the restriction orifice, for quick filling the system with the pressurized gas. In some embodiments, the gauge port is in close proximity to the regulator. The restriction orifice is downstream of the regulator such that the AMD is configured to restrict the flow after the regulator. Typically, dry fire protection systems have a piping network with a volume in a range from 100 gallons to 2000 gallons, or more. Trying to set the regulator to the correct pressure can be difficult when the regulator is attached to a large system (e.g., closer to 2000 gallons or more). The restriction orifice (or a ball valve) being downstream of the gauge port creates a small volume of air that responds quickly to any adjustments in gas pressure.

In some embodiments, the unibody AMD includes, in serial flow relationship, an inlet, a check valve, a three-way ball valve, a strainer, a regulator, a gauge port, a restriction orifice, a ball valve, and an outlet. In some embodiments, the unibody AMD includes, in serial flow relationship, an inlet, a single three-way ball valve as the shutoff valve/bypass valve, a strainer, a regulator, a gauge port, a restriction orifice with an integrated check valve, and an outlet. In some embodiments, the gauge port can be excluded. In such embodiments, the unibody AMD includes, in serial flow relationship, an inlet, a single three-way ball valve as the shutoff valve/bypass valve, a strainer, a regulator, a restriction orifice, a check valve (that isolates the regulator and the strainer for maintenance, thus, removing the need for a second shutoff valve). In some embodiments, the unibody AMD includes, in serial flow relationship, an inlet, a single three-way ball valve as the shutoff valve/bypass valve, a regulator, a gauge port, a restriction orifice, and a check valve. The strainer could be coupled to the unibody AMD, for example, to the inlet of the unibody AMD.

Accordingly, the unibody AMD of the present disclosure incorporates all of the functions of the strainer, the regulator, the gauge port, the restriction orifice, etc., into one compact unit (e.g., a unibody device). Thus, the unibody AMD of the present disclosure provides for a reduced cost, a reduced size, a reduced weight, fewer leakage points (due to no connections between the various components), and a simplification and an overall cleaner, more intentional design appearance, as compared to AMDs without the benefit of the present disclosure. Further, incorporating all of the components into a single unibody assembly removes the need for costly and temperamental connections of the components (e.g., removes the external connections, and, thus, removes the need for seals between the components). Moreover, the sealing portion (e.g., the regulator orifice, the diaphragm, or the piston) of the regulator of the unibody AMD herein is inside the strainer, thereby reducing the overall size of the regulator valve, and, thus, reducing the overall size of the AMD.

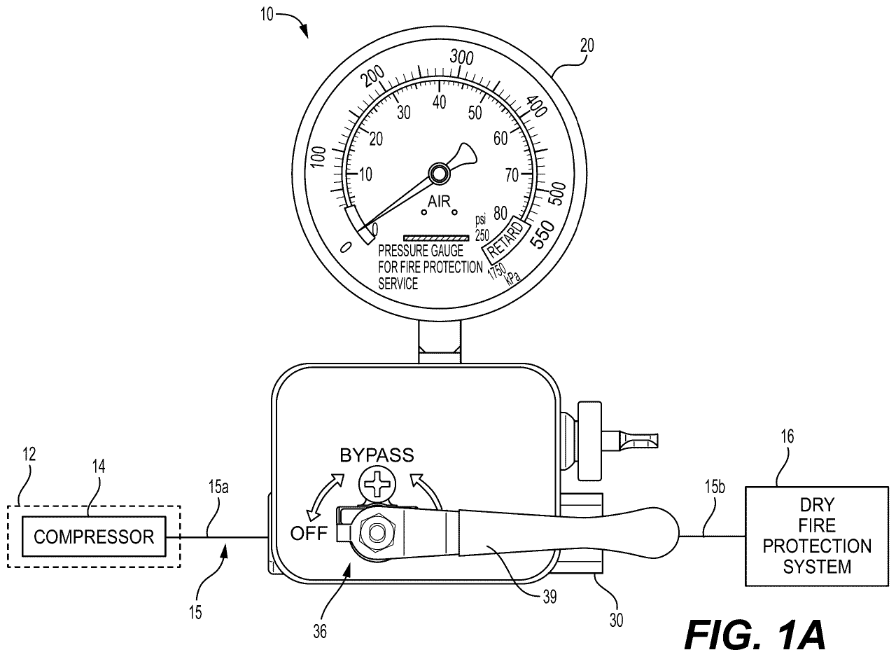

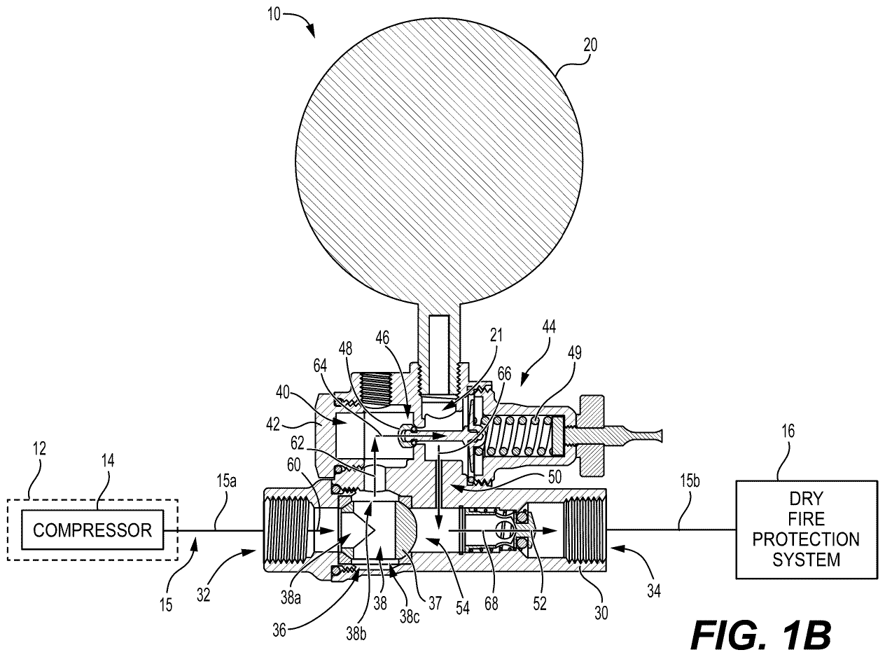

Referring now to the drawings, FIGS. 1A and 1B show a unibody air maintenance device (AMD) 10 in a regulate position. The unibody AMD 10 is a device that is interposed between a pressurized gas source 12 and a dry fire protection system 16. In particular, the unibody AMD 10 is fluidly coupled to a pressurized gas supply line 15 between the pressurized gas source 12 and the dry fire protection system 16. The pressurized gas source 12 includes a compressor 14 for compressing and pressurizing a gas, such as, for example, air or nitrogen. The pressurized gas source 12 can also include a gas generator, a gas storage tank, or any other components for generating the pressurized gas and storing the pressurized gas prior to supplying the pressurized gas to the dry fire protection system 16. The pressurized gas supply line 15 includes one or more pipes, or the like, for directing the pressurized gas therethrough. The pressurized gas supply line 15 includes an upstream pressurized gas supply line 15a that is upstream of the unibody AMD 10 and a downstream pressurized gas supply line 15b that is downstream of the unibody AMD 10.

The dry fire protection system 16 is configured to supply water to a coverage area. In particular, the dry fire protection system 16 includes one or more sprinklers that comprise a sprinkler head, a tube, a pipe connector at an inlet end of the tube that connects the inlet end to a pipe network of the dry fire protection system, a plug seal at the inlet end to prevent water from entering the tube, and an actuating mechanism to maintain the plug seal at the inlet end. The plug seal is held closed with the pressurized gas from the pressurized gas source 12. When an elevated temperature occurs (e.g., during a fire), the thermally responsive support element fails, releasing the plug seal (and also any lower seal at the sprinkler head end of the tube) to allow water from the fluid supply conduit to flow into and through the tube to the sprinkler head, whereupon the fluid is distributed by the sprinkler head.

The unibody AMD 10 includes a gauge 20 and a body 30, also referred to as a unibody. The gauge 20 includes a gauge port 21. The body 30 is a single, integral component that houses the components of the unibody AMD 10 detailed herein. In particular, the unibody AMD 10 includes an inlet 32, an outlet 34, and a three-way valve 36, a strainer 40, a regulator 44, a restriction orifice 50, a check valve 52, and a bypass passage 54 all disposed within the body 30. As shown in FIG. 1B, the inlet 32, the three-way valve 36, the strainer 40, the regulator 44, the gauge port 21, the restriction orifice 50, and the outlet 34 are in serial flow relationship. The bypass passage 54 is disposed between the inlet 32 and the outlet 34. The flow of the pressurized gas through the unibody AMD 10 will be detailed further below. The unibody AMD 10 is fluidly coupled to the pressurized gas supply line 15. In particular, the inlet 32 is fluidly coupled to the upstream pressurized gas supply line 15a and the outlet 34 is fluidly coupled to the downstream pressurized gas supply line 15b (e.g., the piping of the dry fire protection system 16).

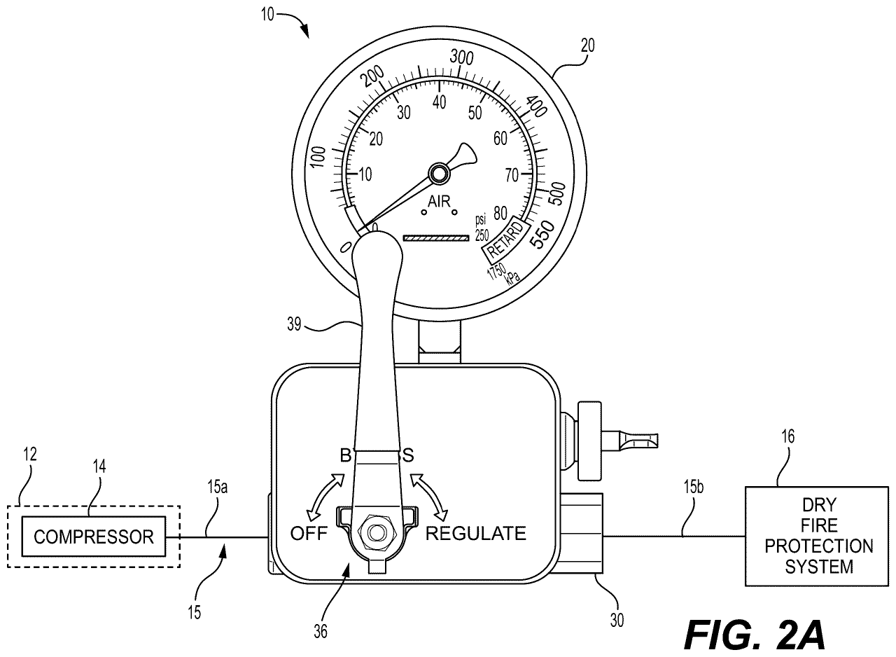

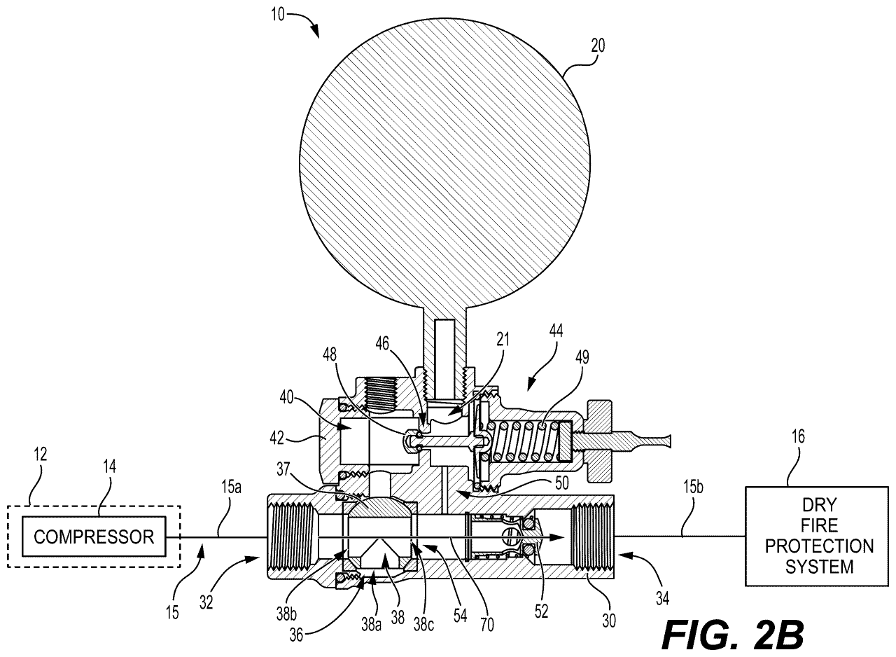

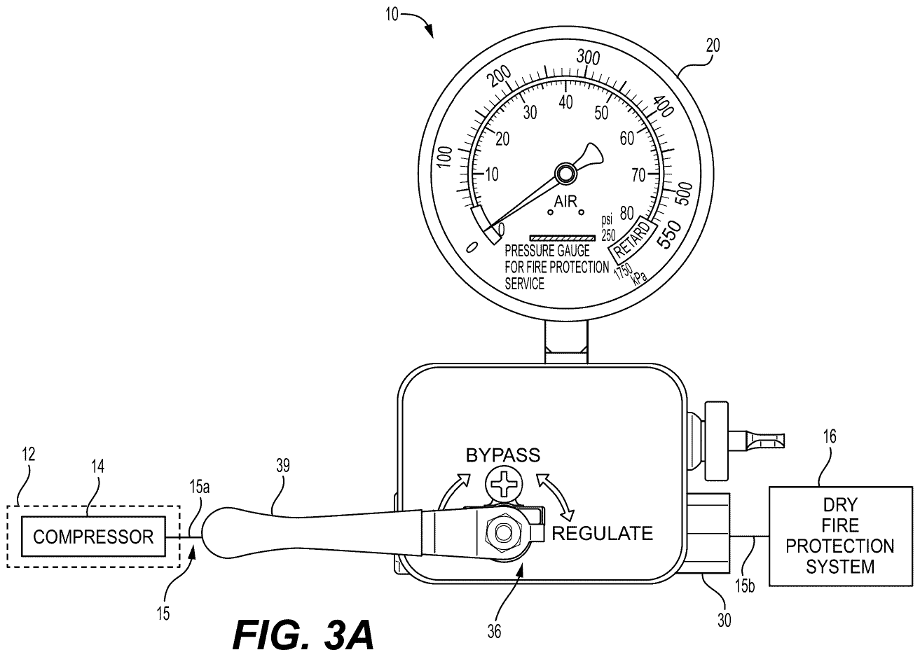

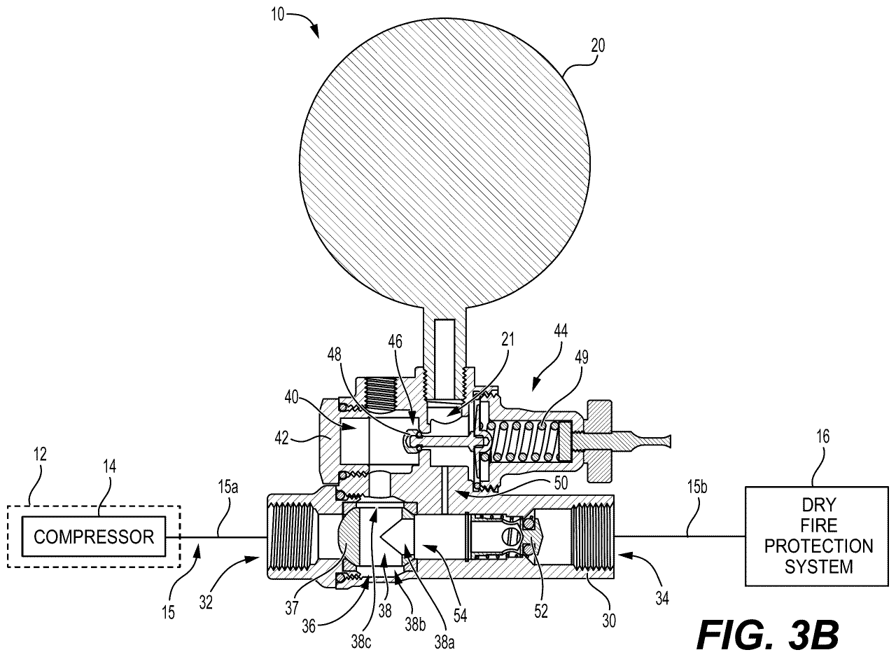

The three-way valve 36 is downstream of the inlet 32. The three-way valve 36 includes a valve body 37, a valve passage 38, and a valve actuator 39. The valve body 37 is a ball. The valve passage 38 is disposed through the valve body 37 for directing the pressurized gas through the three-way valve 36. The valve passage 38 includes three ports, thus, defining the three-way valve 36. The three ports include a first port 38a, a second port 38b, and a third port 38c. The valve actuator 39 is a handle, or the like, such that a user (e.g., a maintenance technician) can rotate the three-way valve 36 among the regulate position (FIGS. 1A and 1B), the bypass position (FIGS. 2A and 2B), or the off position (FIGS. 3A and 3B), as detailed further below.

The strainer 40 is downstream of the three-way valve 36. The strainer 40 is a space within the unibody AMD 10 that is configured to collect solid particles or small debris (e.g., scale, dust, dirt, rust, or the like) that may be in the flow of the pressurized gas. For example, the strainer 40 can include a screen, a filter, or the like, for catching the debris as the pressurized gas flows through the strainer 40. In this way, the strainer 40 prevents the particles or the small debris from entering the regulator 44 or the restriction orifice 50. The strainer 40 includes a strainer cap 42 for closing the strainer 40 after assembly. The strainer cap 42 can be removed for removing or for cleaning the strainer 40 during maintenance.

The regulator 44 is downstream of the strainer 40. The regulator 44 includes a regulator orifice 46, a diaphragm 48, and a regulator actuator 49. The regulator 44 is configured to maintain the pressure of the pressurized gas to the dry fire protection system 16. The diaphragm 48 is sized and is shaped to selectively close or open the regulator orifice 46, as detailed further below. The diaphragm 48 is coupled to the regulator actuator 49. The regulator actuator 49 is a piston attached to a spring, or the like, and can be adjusted, for example, by a user, to set the regulator 44 to a desired pressure for the pressurized gas that flows to the dry fire protection system 16. In particular, the pressurized gas flows through the regulator orifice 46 and the diaphragm 48 opens or closes the regulator orifice 46 based on the pressure of the pressurized gas. In particular, the pressure balance is maintained across the diaphragm 48 and moves the regulator actuator 49. In this way, the regulator 44 maintains the pressure of the pressurized gas at the desired pressure.

A portion of the regulator 44 is disposed within the strainer 40. For example, at least one of the regulator orifice 46, the diaphragm 48, or a portion of the regulator actuator 49 (e.g., the piston) is disposed within the strainer 40. In this way, the regulator 44 includes a reduced size as compared to AMDs without the benefit of the present disclosure.

The gauge port 21 is downstream of the regulator 44. The gauge port 21 directs a portion of the pressurized gas therethrough to the gauge 20 such that the gauge 20 provides an indication of the pressure of the pressurized gas through the unibody AMD 10.

The restriction orifice 50 is downstream of the regulator 44 (and the gauge port 21). The restriction orifice 50 is an orifice within the unibody AMD 10 that reduces a flow rate of the pressurized gas flowing to the dry fire protection system 16. In particular, the restriction orifice 50 is sized so that the flow rate of the pressurized gas of an open sprinkler is greater than the flow rate of the pressurized gas supplied through the unibody AMD 10. In this way, the dry fire protection system 16 loses pressure upon sprinkler activation, but the unibody AMD 10 can maintain the pressure in the dry fire protection system 16 even if there are small leaks in the dry fire protection system 16. A diameter of the restriction orifice 50 is less than a diameter of the regulator orifice 46. In this way, the restriction orifice 50 reduces the flow rate of the pressurized gas from the regulator 44 towards the outlet 34.

The check valve 52 is downstream of the restriction orifice 50 and upstream of the outlet 34. The check valve 52 is a one-way valve that allows the pressurized gas to flow in one direction, particularly, in from the pressurized gas source 12 to the dry fire protection system 16. The check valve 52 opens to allow the pressurized gas to flow to the dry fire protection system 16. The check valve 52 closes to prevent the pressurized gas from flowing from the dry fire protection system 16 towards the pressurized gas source 12, as detailed further below.

In operation, when the unibody AMD 10 is in the regulate position, the regulator 44 regulates the pressure of the pressurized gas to the dry fire protection system 16. In particular, the inlet 32 directs the pressurized gas into the unibody AMD 10 (as shown by arrow 60). In the regulate position, the three-way valve 36 is oriented such that the valve passage 38 is in fluid communication with the inlet 32 and the strainer 40. In particular, the first port 38a is in fluid communication with the inlet 32 and the second port 38b is in fluid communication with the strainer 40. In this way, the three-way valve 36 directs the pressurized gas from the inlet 32 to the strainer 40 (as shown by arrow 62). The valve body 37 of the three-way valve 36 prevents the pressurized gas from flowing through the bypass passage 54 when the unibody AMD 10 is in the regulate position. The strainer 40 filters the solid particles, as detailed above, as the pressurize gas flows through the strainer 40. The strainer 40 directs the pressurized gas to the regulator 44.

The regulator 44 directs the pressurized gas through the regulator orifice 46 (as shown by arrow 64). The diaphragm 48 opens or closes based on the pressure of the pressurized gas to maintain the pressure of the pressurized gas at a desired pressure, as detailed above. In this way, the unibody AMD 10 regulates the pressure of the pressurized gas to the dry fire protection system 16 at a desired pressure when the unibody AMD 10 is in the regulate position. The regulator 44 then directs the pressurized gas to the restriction orifice 50.

The restriction orifice 50 directs the pressurized gas through the restriction orifice 50 and to the check valve 52 (as shown by arrow 66). When the unibody AMD 10 is in the regulate position, a pressure of the pressurized gas from the pressurized gas source 12 is greater than a threshold pressure for opening the check valve 52. Thus, the check valve 52 is opened in the regulate position, and the check valve 52 directs the pressurized gas therethrough and to the outlet 34 (as shown by arrow 68). The outlet 34 directs the pressurized gas to the downstream pressurized gas supply line 15b and towards the dry fire protection system 16.

FIGS. 2A and 2B show the unibody AMD 10 in the bypass position. In the bypass position, the user (technician) has moved the valve actuator 39 to the bypass position. In the bypass position, the three-way valve 36 is oriented such that the valve passage 38 is in fluid communication with the inlet 32 and the bypass passage 54. In particular, the second port 38b is in fluid communication with the inlet 32 and the third port 38c is in fluid communication with the bypass passage 54. In this way, the three-way valve 36 directs the pressurized gas from the inlet 32 to the bypass passage 54 towards the check valve 52 (as shown by arrow 70). The valve body 37 of the three-way valve 36 prevents the pressurized gas from flowing to the strainer 40, the regulator 44, and the restriction orifice 50 when the unibody AMD 10 is in the bypass position. In this way, the pressurized gas bypasses the regulator 44 and is supplied to the dry fire protection system 16 faster than when the unibody AMD 10 is in the regulate position. When the unibody AMD 10 is in the bypass position, a pressure of the pressurized gas from the pressurized gas source 12 is greater than a threshold pressure for opening the check valve 52. Thus, the check valve 52 is opened in the bypass position, and the check valve 52 directs the pressurized gas therethrough and to the outlet 34. The outlet 34 directs the pressurized gas to the downstream pressurized gas supply line 15b and towards the dry fire protection system 16. The bypass position allows for a quick fill of the dry fire protection system 16 with the pressurized gas (e.g., in thirty minutes or less).

FIGS. 3A and 3B show the unibody AMD 10 in the off position. In the off position, the user (technician) has moved the valve actuator 39 to the off position. In the off position, the three-way valve 36 is oriented such that the valve body 37 is disposed to prevent the pressurized gas from flowing through the unibody AMD 10. In particular, the valve body 37 blocks the inlet 32 and prevents the pressurized gas from flowing from the pressurized gas source 12 into the unibody AMD 10. In this way, the three-way valve 36 prevents the pressurized gas from flowing through the strainer 40, the regulator 44, and the restriction orifice 50, and prevents the pressurized gas from flowing through the bypass passage 54. In the off position, the check valve 52 is closed due to the pressure of the pressurized gas from the dry fire protection system 16 being greater than the pressure of within the unibody AMD 10 (since there is no pressurized gas flowing into the unibody AMD 10 from the pressurized gas source 12). In this way, the check valve 52 prevents the pressurized gas from the dry fire protection system 16 from flowing through the unibody AMD 10 and towards the pressurized gas source 12 in the off position. Thus, the user can turn the unibody AMD 10 to the off position to perform maintenance on the unibody AMD 10 without draining the pressurized gas from the pressurized gas source 12 and from the dry fire protection system 16. For example, the user can perform maintenance on one or more of the strainer 40, the regulator 44, the restriction orifice 50, the check valve 52, or the gauge 20.

Accordingly, the unibody AMD 10 incorporates all of the functions of the strainer 40, the regulator 44, the gauge port 21, the restriction orifice 50, etc., into one compact unit (e.g., a unibody device). Thus, the unibody AMD 10 provides for a reduced cost, a reduced size, a reduced weight, fewer leakage points (due to no external connections between the various components), and a simplification and an overall cleaner, more intentional design appearance, as compared to AMDs without the benefit of the present disclosure. In particular, the unibody AMD 10 provides a simplified design as compared to AMDs without the benefit of the present disclosure due to having only a single valve (the three-way valve 36) to actuate to turn off to turn on the unibody AMD 10. Further, incorporating all of the components into a single unibody assembly removes the need for costly and temperamental connections of the components (e.g., removes the external connections, and, thus, removes the need for seals between the components). Moreover, a portion of the regulator 44 (e.g., the regulator orifice 46, the diaphragm 48, or the regulator actuator 49) is disposed inside the strainer 40, thereby reducing the overall size of the regulator 44.

Although the foregoing description is directed to the preferred embodiments of the present disclosure, other variations and modifications will be apparent to one with skill in the art that the storage fire protection sprinklers of the invention may be provided using some or all of the mentioned features and components without departing from the spirit and the scope of the present invention. Also, the embodiments described above are specific examples of a single broader invention that may have greater scope than any of the singular descriptions taught. There may be many alterations made in the descriptions without departing from the spirit and the scope of the present invention. Moreover, features described in connection with one embodiment of the present disclosure may be used in conjunction with other embodiments, even if not explicitly stated above.

1. A unibody air maintenance device for a dry fire protection system, the unibody air maintenance device comprising:
a body that is a single, integral component, the body having an inlet and an outlet, the inlet being configured to receive a pressurized gas from a pressurized gas source and the outlet being configured to direct the pressurized gas to the dry fire protection system;
a regulator disposed within the body and downstream of the inlet, the regulator being configured to maintain a pressure of the pressurized gas through the unibody air maintenance device at a set pressure;
a check valve disposed within the body and downstream of the regulator, the check valve being configured to open to allow the pressurized gas to flow from the inlet towards the outlet and to close to prevent the pressurized gas from flowing from the outlet towards the inlet; and
a three-way valve disposed within the body downstream of the inlet and upstream of the regulator, the three-way valve being configured to allow the pressurized gas to flow towards the regulator in a regulate position and to prevent the pressurized gas from flowing through the unibody air maintenance device in an off position.

2. The unibody air maintenance device of claim 1, wherein the three-way valve includes a valve actuator that is configured to actuate the three-way valve from the regulate position to the off position.

3. The unibody air maintenance device of claim 1, further comprising a bypass passage disposed within the body, downstream of the three-way valve and upstream of the check valve, wherein the three-way valve is configured to allow the pressurized gas through the bypass passage towards the outlet and to prevent the pressurized gas from flowing to the regulator in a bypass position.

4. The unibody air maintenance device of claim 1, further comprising a gauge configured to provide an indication of the pressure of the pressurized gas, wherein the gauge includes a gauge port disposed within the body downstream of the regulator and upstream of the check valve.

5. The unibody air maintenance device of claim 1, further comprising a strainer disposed within the body downstream of the three-way valve and upstream of the regulator, wherein the strainer is configured to collect solid particles or debris within the pressurized gas from the pressurized gas source.

6. The unibody air maintenance device of claim 1, further comprising a restriction orifice disposed within the body downstream of the regulator and upstream of the check valve, the restriction orifice being configured to reduce a flow rate of the pressurize gas through the restriction orifice and towards the outlet.

7. The unibody air maintenance device of claim 6, wherein a diameter of the restriction orifice is less than a diameter of the regulator.

8. The unibody air maintenance device of claim 1, wherein the regulator includes a regulator orifice and a diaphragm configured to open and to close the regulator orifice to maintain the pressure of pressurized air through the unibody air maintenance device at the set pressure.

9. The unibody air maintenance device of claim 8, wherein the regulator includes a regulator actuator, the diaphragm being coupled to the regulator actuator, and the regulator actuator being configured to actuate the diaphragm to open and to close the regulator orifice.

10. The unibody air maintenance device of claim 8, further comprising a strainer disposed within the body downstream of the three-way valve and upstream of the regulator, wherein a portion of the regulator is disposed within strainer.

11. The unibody air maintenance device of claim 1, wherein the three-way valve has a valve body and a valve passage, the valve body being configured to block the inlet in the off position, and the valve passage being configured to allow the pressurized gas to flow to the regulator in the regulate position.

12. The unibody air maintenance device of claim 11, wherein the valve passage includes a first port, a second port, and a third port, the first port being in fluid communication with the inlet and the second port being in fluid communication with the regulator in the regulate position such that the unibody air maintenance device is configured to regulate the pressure of the pressurized gas to the dry fire protection system in the regulate position.

13. The unibody air maintenance device of claim 12, wherein the second port is in fluid communication with the inlet, the third port is in fluid communication with the check valve, and the valve body blocks flow of the pressurized gas to the regulator in a bypass position such that the unibody air maintenance device is configured to bypass the regulator in the bypass position.

14. A system comprising:
a dry fire protection system configured to distribute water to a coverage area;
a pressurized gas source configured to supply a pressurized gas to the dry fire protection system;
a pressurized gas supply line configured to supply the pressurized gas from the pressurized gas source to the dry fire protection system; and
a unibody air maintenance device fluidly coupled to the pressurized gas supply line, the unibody air maintenance device comprising:
a body that is a single, integral component, the body having an inlet and an outlet, the inlet being configured to receive the pressurized gas from the pressurized gas source and the outlet being configured to direct the pressurized gas to the dry fire protection system;
a regulator disposed within the body and downstream of the inlet, the regulator being configured to maintain a pressure of the pressurized gas through the unibody air maintenance device at a set pressure;
a check valve disposed within the body and downstream of the regulator, the check valve being configured to open to allow the pressurized gas to flow from the inlet towards the outlet and to close to prevent the pressurized gas from flowing from the outlet towards the inlet; and
a three-way valve disposed within the body downstream of the inlet and upstream of the regulator, the three-way valve being configured to allow the pressurized gas to flow towards the regulator in a regulate position and to prevent the pressurized gas from flowing through the unibody air maintenance device in an off position.

15. The system of claim 14, further comprising a bypass passage disposed within the body, downstream of the three-way valve and upstream of the check valve, wherein the three-way valve is configured to allow the pressurized gas through the bypass passage towards the outlet and to prevent the pressurized gas from flowing to the regulator in a bypass position.

16. The system of claim 14, further comprising a gauge configured to provide an indication of the pressure of the pressurized gas, wherein the gauge includes a gauge port disposed within the body downstream of the regulator and upstream of the check valve.

17. The system of claim 14, further comprising a strainer disposed within the body downstream of the three-way valve and upstream of the regulator, wherein the strainer is configured to collect solid particles or debris within the pressurized gas from the pressurized gas source.

18. The system of claim 14, further comprising a restriction orifice disposed within the body downstream of the regulator and upstream of the check valve, the restriction orifice being configured to reduce a flow rate of the pressurize gas through the restriction orifice and towards the outlet.

19. The system of claim 14, wherein the regulator includes a regulator orifice and a diaphragm configured to open and to close the regulator orifice to maintain the pressure of pressurized air through the unibody air maintenance device at the set pressure.

20. The system of claim 19, further comprising a strainer disposed within the body downstream of the three-way valve and upstream of the regulator, wherein a portion of the regulator is disposed within strainer.
